(19) United States
(12) Patent Application Publication
(10) Pub. No.: US 2025/0129912 A1
(43) Pub. Date: Apr. 24, 2025

(54) PROJECTOR DEVICE

(71) Applicant: Qisda Corporation, Taoyuan City (TW)

(72) Inventors: Hsin-Liang Chen, Taoyuan City (TW); Chun Ming Shen, Taoyuan City (TW); Chien Yu Shih, Taoyuan City (TW)

(73) Assignee: Qisda Corporation, Taoyuan City (TW)

(21) Appl. No.: 18/904,013

(22) Filed: Oct. 1, 2024

(30) Foreign Application Priority Data
Oct. 24, 2023 (CN) 202311379546.8

(51) Int. Cl. F21S 45/43; F21S 41/176; F21S 41/25

(52) U.S. Cl. CPC F21S 45/43; F21S 41/176; F21S 41/25

(57) ABSTRACT

A projector device including a device body, a first heat dissipation component, a second heat dissipation component, a third heat dissipation component, and a heat dissipation fan. The device body includes a light emitting element, a wavelength conversion element, a light valve, and a projection lens. The first heat dissipation component, the second heat dissipation component, and the third heat dissipation component are connected to the light emitting element, the light valve, and the wavelength conversion element. The heat dissipation fan has an air outlet surface and is adapted to provide a heat dissipation airflow. The air outlet surface faces at least one of the first heat dissipation component, the second heat dissipation component, and the third heat dissipation component. The first heat dissipation component, the second heat dissipation component and the third heat dissipation component are all located on at least one flow path of the heat dissipation airflow.

### CROSS-REFERENCE TO RELATED APPLICATION

This application claims the priority benefit of China application serial no. 202311379546.8, filed on Oct. 24, 2023. The entirety of the above-mentioned patent application is hereby incorporated by reference herein and made a part of this specification.

### BACKGROUND

### Technical Field

The disclosure relates to an optical device, and in particular to a projector device.

### Description of Related Art

The application level of micro-projector devices is becoming more and more extensive. They can be used in automotive lighting systems and used with adaptive driving beam (ADB) technology to project driving information. Micro-projector devices generally use heat dissipation fin sets and heat dissipation fans to dissipate heat from the laser light source, the light valve, and the fluorescent wheel thereof. However, multiple heat dissipation fin sets corresponding to the laser light source, the light valve, and the fluorescent wheel usually require multiple heat dissipation fans respectively used for heat dissipation. This configuration limits the miniaturization design of the micro-projector device.

### SUMMARY

The disclosure provides a projector device that can have a smaller volume.

The projector device of the disclosure includes a device body, a first heat dissipation component, a second heat dissipation component, a third heat dissipation component, and a heat dissipation fan. The device body of the device includes a light emitting element, a wavelength conversion element, a light valve, and a projection lens. The light emitting element is suitable for emitting an illumination beam. The wavelength conversion element is suitable for converting a wavelength of part of the illumination beam. The light valve is suitable for converting the illumination beam from the light emitting element and the wavelength conversion element into an image beam. The projection lens is suitable for projecting the image beam. The first heat dissipation component, the second heat dissipation component, and the third heat dissipation component are respectively connected to the light emitting element, the light valve, and the wavelength conversion element. The heat dissipation fan has an air outlet surface and is suitable for providing a heat dissipation airflow. The air outlet surface faces at least one of the first heat dissipation component, the second heat dissipation component, and the third heat dissipation component. The first heat dissipation component, the second heat dissipation component, and the third heat dissipation component are all located on at least one flow path of the heat dissipation airflow.

In an embodiment of the disclosure, the air outlet surface faces the first heat dissipation component and the third heat dissipation component. The first heat dissipation component is located between the heat dissipation fan and the second heat dissipation component and has a through via. At least one flow path includes three flow paths. One flow path passes through the first heat dissipation component, another one flow path sequentially passes through the through via and the second heat dissipation component, and the other flow path passes through the third heat dissipation component.

In an embodiment of the disclosure, the first heat dissipation component includes a board and a heat dissipation fin set. The board has a first opening. The heat dissipation fin set is arranged on the board and has a second opening. The first opening and the second opening are aligned with each other to form a through via.

In an embodiment of the disclosure, the projector device further includes a frame, wherein the frame has a guide slope extending in a direction from the through via to the second heat dissipation component.

In an embodiment of the disclosure, the projector device further includes a first circuit board and a second circuit board. The second heat dissipation component is disposed on the first circuit board. The frame is located between the first circuit board and the second circuit board to support the second circuit board away from the first circuit board.

In an embodiment of the disclosure, the second circuit board has at least one heat generating element. The frame has a slot. At least one flow path sequentially passes through the through via, the space between the first circuit board and the frame, the slot, and the at least one heat generating element.

In an embodiment of the disclosure, the guide slope is formed on the edge of the slot.

In an embodiment of the disclosure, the heat dissipation fan has an air inlet surface. The air inlet surface faces the second heat dissipation component. The air outlet surface faces the first heat dissipation component. The first heat dissipation component is located between the heat dissipation fan and the third heat dissipation component. At least one flow path sequentially passes through the second heat dissipation component, the heat dissipation fan, the first heat dissipation component, and the third heat dissipation component.

In an embodiment of the disclosure, the air inlet surface is perpendicular to the air outlet surface.

In an embodiment of the disclosure, the first heat dissipation component faces the heat dissipation fan along a first direction. The first heat dissipation component faces the third heat dissipation component along a second direction different from the first direction. At least one flow path sequentially passes through the heat dissipation fan and the first heat dissipation component along the first direction and sequentially passes through the first heat dissipation component and the third heat dissipation component along the second direction.

In an embodiment of the disclosure, the projector device further includes a housing. The first heat dissipation component, the second heat dissipation component, the third heat dissipation component, and the heat dissipation fan are at least partially accommodated by the housing. The housing guides the heat dissipation airflow to sequentially flow along the first direction and the second direction.

In an embodiment of the disclosure, the first direction is perpendicular to the second direction.

In an embodiment of the disclosure, the air outlet surface faces the first heat dissipation component, the second heat dissipation component, and the third heat dissipation component. At least one flow path includes three flow paths. The three flow paths respectively passes through the first heat dissipation component, the second heat dissipation component, and the third heat dissipation component.

In an embodiment of the disclosure, the second heat dissipation component and the third heat dissipation component overlap with each other in a vertical direction parallel to the air outlet surface. The second heat dissipation component and the third heat dissipation component overlap with the first heat dissipation component in a horizontal direction parallel to the air outlet surface.

In an embodiment of the disclosure, the air outlet surface faces the second heat dissipation component and the third heat dissipation component. The third heat dissipation component is located between the heat dissipation fan and the first heat dissipation component. At least one flow path includes two flow paths. One flow path passes through the second heat dissipation component, and another flow path sequentially passes through the third heat dissipation component and the first heat dissipation component.

In an embodiment of the disclosure, when viewed along an air outlet direction of the heat dissipation fan, the first heat dissipation component, the second heat dissipation component, and the third heat dissipation component all overlap at the heat dissipation fan.

In an embodiment of the disclosure, the first heat dissipation component has a first contact surface contacting the light emitting element. The second heat dissipation component has a second contact surface contacting the light valve. The third heat dissipation component has a third contact surface contacting the wavelength conversion element. The first contact surface, the second contact surface, and the third contact surface are not parallel to each other.

In an embodiment of the disclosure, an included angle between any two of the first contact surface, the second contact surface, and the third contact surface is between 45 degrees and 135 degrees.

In an embodiment of the disclosure, the first heat dissipation component has a first contact surface contacting the light emitting element. The second heat dissipation component has a second contact surface contacting the light valve. The third heat dissipation component has a third contact surface contacting the wavelength conversion element. The first contact surface is parallel to one of the second contact surface and the third contact surface and not parallel to the other of the second contact surface and the third contact surface.

In an embodiment of the disclosure, an included angle between the first contact surface and the other one of the second contact surface and the third contact surface is between 45 degrees and 135 degrees.

In an embodiment of the disclosure, the projector device is a vehicle light.

Based on the above, the disclosure arranges the first heat dissipation component, the second heat dissipation component, and the third heat dissipation component respectively corresponding to the light emitting element, the light valve, and the wavelength conversion element to be located on the flow path of the heat dissipation airflow provided by a single heat dissipation fan. Thereby, the first heat dissipation component, the second heat dissipation component, and the third heat dissipation component may be dissipated by the single heat dissipation fan. Accordingly, there is no need to configure multiple heat dissipation fans respectively corresponding to the first heat dissipation component, the second heat dissipation component, and the third heat dissipation component, which facilitates the miniaturization design of the projector device.

### BRIEF DESCRIPTION OF THE DRAWINGS

FIG. 1 is a schematic view of a projector device according to an embodiment of the disclosure.

FIG. 2 is a perspective view of some components of the device body in FIG. 1.

FIGS. 3 to 5 are respectively perspective views of some components of the projector device in FIG. 1 from different viewing angles

FIG. 6 shows that the light emitting element, the light valve, and the wavelength conversion element of FIG. 2 are respectively connected to a first heat dissipation component, a second heat dissipation component, and a third heat dissipation component.

FIG. 7 is a side view of some components of a projector device according to another embodiment of the disclosure.

FIG. 8 is a perspective view of some components of the device body in FIG. 7.

FIG. 9 shows that the light emitting element, the light valve, and the wavelength conversion element of FIG. 8 are respectively connected to the first heat dissipation component, the second heat dissipation component, and the third heat dissipation component.

FIG. 10 is a perspective view of some components of a projector device according to another embodiment of the disclosure.

FIG. 11 is a perspective view of some components of the device body of FIG. 10.

FIG. 12 shows that the light emitting element, the light valve, and the wavelength conversion element of FIG. 11 are respectively connected to the first heat dissipation component, the second heat dissipation component, and the third heat dissipation component.

FIG. 13 is a side view of some components of a projector device according to another embodiment of the disclosure.

FIG. 14 is a perspective view of some components of the device body of FIG. 13.

### DESCRIPTION OF THE EMBODIMENTS

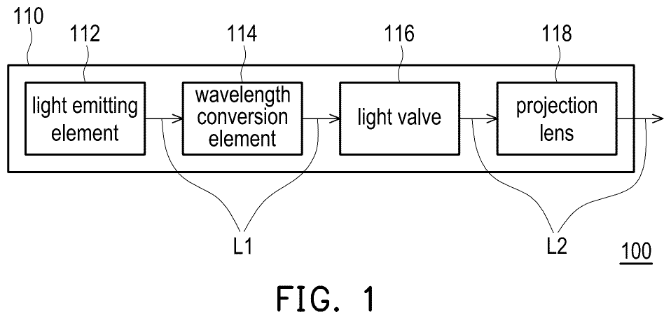

FIG. 1 is a schematic view of a projector device according to an embodiment of the disclosure. Referring to FIG. 1, a projector device 100 of this embodiment includes a device body 110. The device body 110 includes a light emitting element 112, a wavelength conversion element 114, a light valve 116, and a projection lens 118. The light emitting element 112 is suitable for emitting an illumination beam L1. The wavelength conversion element 114 is suitable for converting a wavelength of part of the illumination beam L1. The light valve 116 is suitable for converting the illumination beam L1 from the light emitting element 112 and the wavelength conversion element 114 into an image beam L2. The projection lens 118 is suitable for projecting the image beam L2.

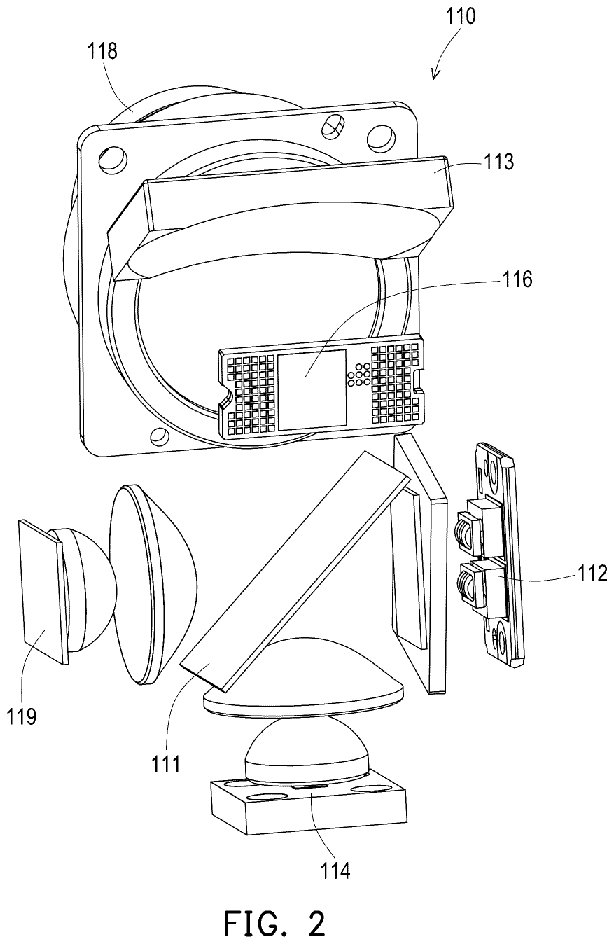

FIG. 2 is a perspective view of some components of the device body in FIG. 1. Referring to FIG. 2, specifically, the device body 110 of this embodiment further includes a light diffusion component 119 and a transflective element 111. The light emitting element 112 is, for example, a blue laser source, and part of blue light emitted from which (i.e., the illumination beam L1 shown in FIG. 1) is reflected by the transflective element 111 to the wavelength conversion element 114. The wavelength conversion element 114 is, for example, a fluorescent wheel and is used to convert the received blue light into yellow light and then transmit the yellow light to the transflective element 111. The yellow light passes through the transflective element 111 and is reflected toward the light valve 116 by the reflective element 113.

Another part of the blue light emitted by the light emitting element 112 (i.e., the illumination beam L1 shown in FIG. 1) passes through the transflective element 111 and reaches the light diffusion component 119, and is diffused by the light diffusion component 119 and transmitted toward the transflective element 111. The blue light is reflected by the transflective element 111 and then reflected by the reflective element 113 toward the light valve 116. The blue light and the yellow light transmitted to the light valve are synthesized into white light. The light valve 116 is, for example, a digital micromirror device (DMD), used to convert the white light into the image beam L2 shown in FIG. 1 and transmit the white light to the projection lens 118.

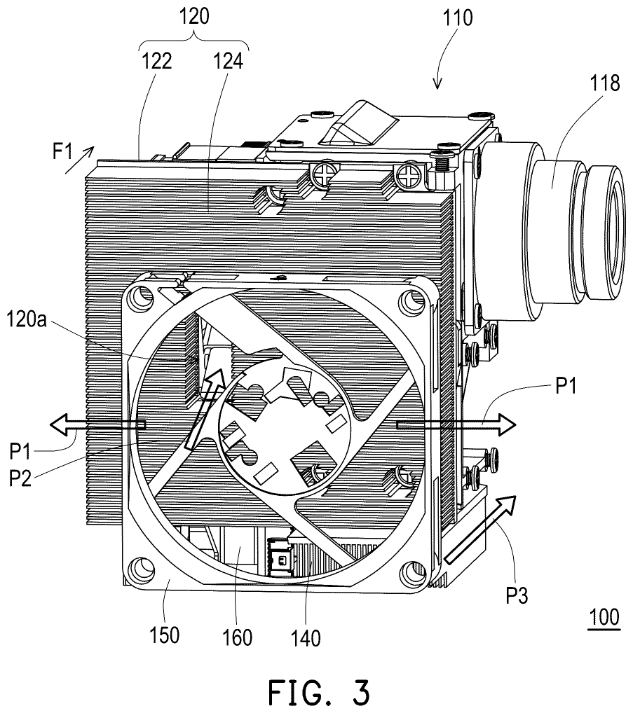

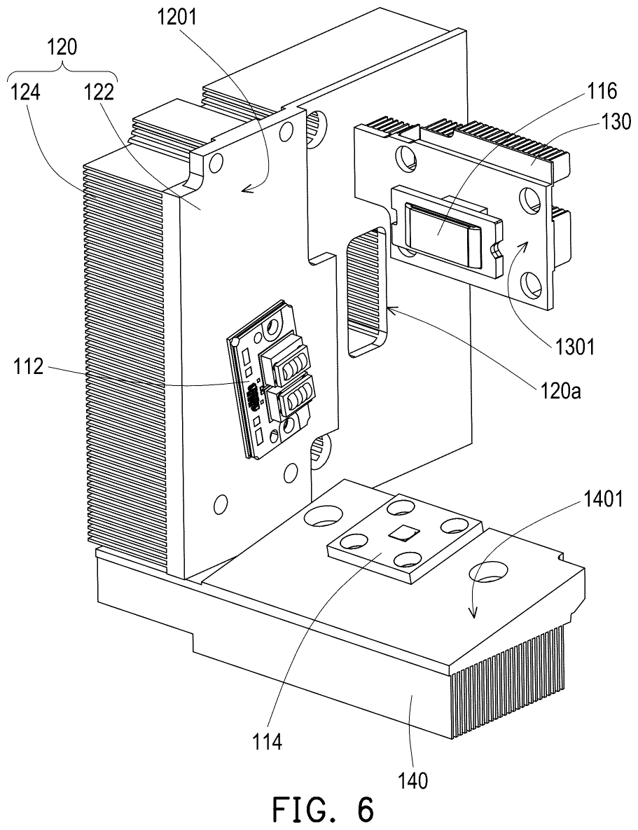

FIGS. 3 to 5 are respectively perspective views of some components of the projector device in FIG. 1 from different viewing angles. FIG. 6 shows that the light emitting element, the light valve, and the wavelength conversion element of FIG. 2 are respectively connected to a first heat dissipation component, a second heat dissipation component, and a third heat dissipation component. Referring to FIGS. 3 to 6, the projector device 100 of this embodiment further includes a first heat dissipation component 120, a second heat dissipation component 130, a third heat dissipation component 140, and a heat dissipation fan 150. The first heat dissipation component 120, the second heat dissipation component 130, and the third heat dissipation component 140 are all, for example, heat dissipation fin structures and are respectively connected to the light emitting element 112, the light valve 114, and the wavelength conversion element 116.

Specifically, the first heat dissipation component 120 has a first contact surface 1201 that contacts the light emitting element 112. The second heat dissipation component 130 has a second contact surface 1301 that contacts the light valve 116. The third heat dissipation component 140 has a third contact surface 1401 that contacts the wavelength conversion element 114. The first contact surface 1201, the second contact surface 1301, and the third contact surface 1401 are not parallel to each other. An included angle between any two of the first contact surface 1201, the second contact surface 1301, and the third contact surface 1401 is, for example, between 45 degrees and 135 degrees.

The heat dissipation fan 150 has an air outlet surface 152 and is suitable for providing a heat dissipation airflow. When viewed along an air outlet direction F1 of the heat dissipation fan 150, the first heat dissipation component 120, the second heat dissipation component 130, and the third heat dissipation component 140 all overlap the heat dissipation fan 150. The air outlet surface 152 faces the first heat dissipation component 120 and the third heat dissipation component 140. The first heat dissipation component 120, the second heat dissipation component 130, and the third heat dissipation component 140 are all located on a flow path of the heat dissipation airflow. Specifically, a flow path P1 of the heat dissipation airflow passes through the first heat dissipation component 120. A flow path P2 of the heat dissipation airflow passes through the second heat dissipation component 130. A flow path P3 of the heat dissipation airflow passes through the third heat dissipation component 140.

As mentioned above, in this embodiment, the first heat dissipation component 120, the second heat dissipation component 130, and the third heat dissipation component 140 respectively corresponding to the light emitting element 112, the light valve 116, and the wavelength conversion element 114 are arranged to be located at the flow path of the heat dissipation airflow provided by the single heat dissipation fan 150. Thereby, the first heat dissipation component 120, the second heat dissipation component 130, and the third heat dissipation component 140 may be dissipated by the single heat dissipation fan 150. Accordingly, there is no need to configure multiple heat dissipation fans respectively corresponding to the first heat dissipation component 120, the second heat dissipation component 130, and the third heat dissipation component 140, which facilitates the miniaturization design of the projector device 100.

In this embodiment, the projector device 100 is, for example, at least a part of a vehicle light. Specifically, the projector device 100 may be a micro-projector device and is used with adaptive driving beam (ADB) technology as the vehicle light for projecting driving information. In other embodiments, the projector device 100 may be other types of projection equipment, and the disclosure is not limited thereto.

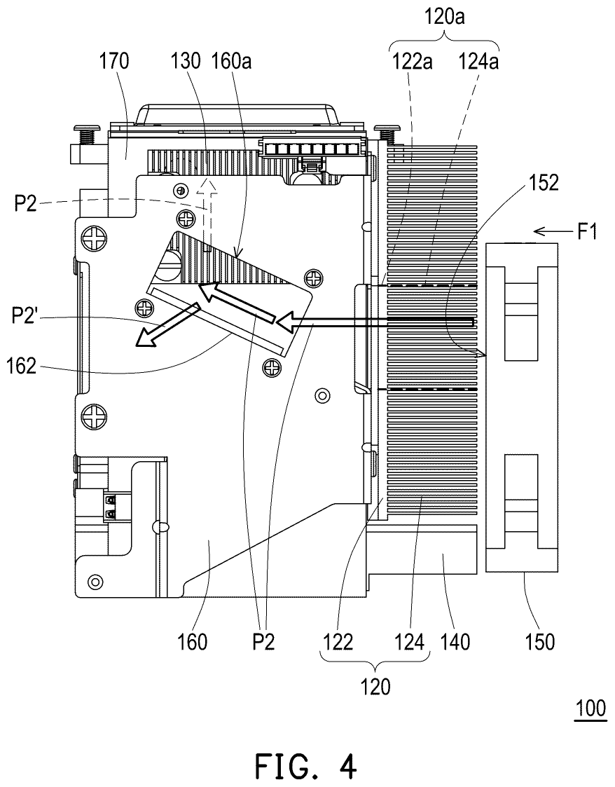

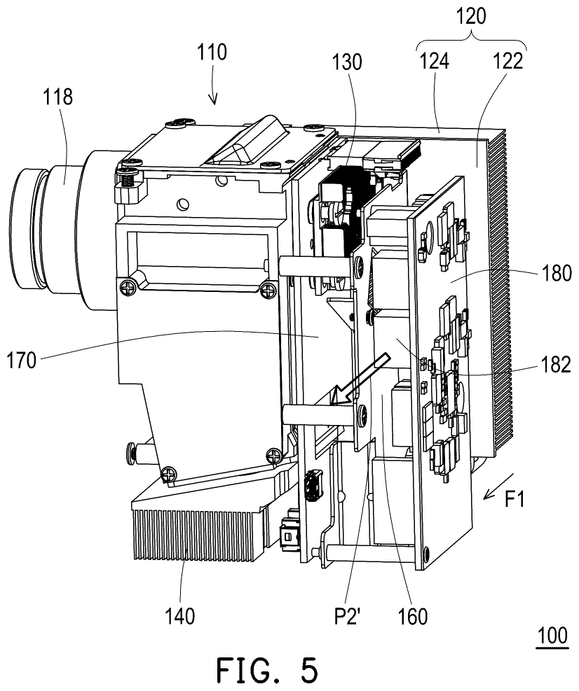

Referring to FIG. 3 and FIG. 4, the first heat dissipation component 120 of this embodiment is located between the heat dissipation fan 150 and the second heat dissipation component 130 and has a through via 120a, so that the flow path P2 sequentially passes through the through via 120a and the second heat dissipation component 130. In detail, the first heat dissipation component 120 includes a board 122 and a heat dissipation fin set 124. The board 122 has a first opening 122a. The heat dissipation fin set 124 is configured on the board 122 and has a second opening 124a. The first opening 122a and the second opening 124a are aligned with each other to form the through via 120a. In addition, referring to FIG. 4 and FIG. 5, the projector device 100 of this embodiment further includes a frame 160. The frame 160 has a guide slope 162. The guide slope 162 extends in a direction from the through via 120a toward the second heat dissipation component 130 to guide the heat dissipation airflow to the second heat dissipation component 130.

Furthermore, the projector device 100 of this embodiment further includes a first circuit board 170 and a second circuit board 180. The first circuit board 170 is, for example, a control circuit board and is provided with the light valve 116 (shown in FIG. 2 and FIG. 6). The second circuit board 180 is, for example, a power drive board. The second heat dissipation component 130 is configured on the first circuit board 170 to connect the light valve 116. The frame 160 is located between the first circuit board 170 and the second circuit board 180 to support the second circuit board 180 away from the first circuit board 170.

Following the above, the second circuit board 180 has at least one heat generating element 182. The frame 160 has a slot 160a. A part of the flow path P2 of the heat dissipation airflow (marked as a flow path P2′ in FIGS. 4 and 5) sequentially passes through the through via 120a, a space between the first circuit board 170 and the frame 160, the slot 160a, and the heat generating element 182 to dissipate heat from the heat generating element 182. Moreover, the guide slope 162 is formed on an edge of the slot 160a, for example.

As mentioned above, the heat dissipation airflow generated by the heat dissipation fan 150 of this embodiment may smoothly flow to the second heat dissipation component 130 through the guidance of the guide slope 162 of the existing frame 160 for assembling the circuit board. In addition to forming the guide slope 162 by the edge thereof, the slot 160a of the frame 160 also allows the heat dissipation airflow to flow to the second circuit board 180, thereby dissipating the heat from the heat generating element 182 on the second circuit board 180 by the heat dissipation airflow generated by the heat dissipation fan 150.

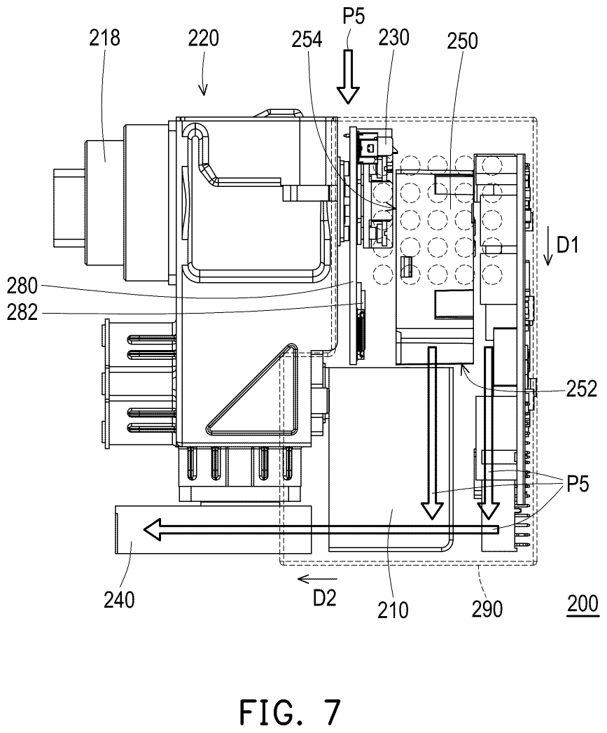

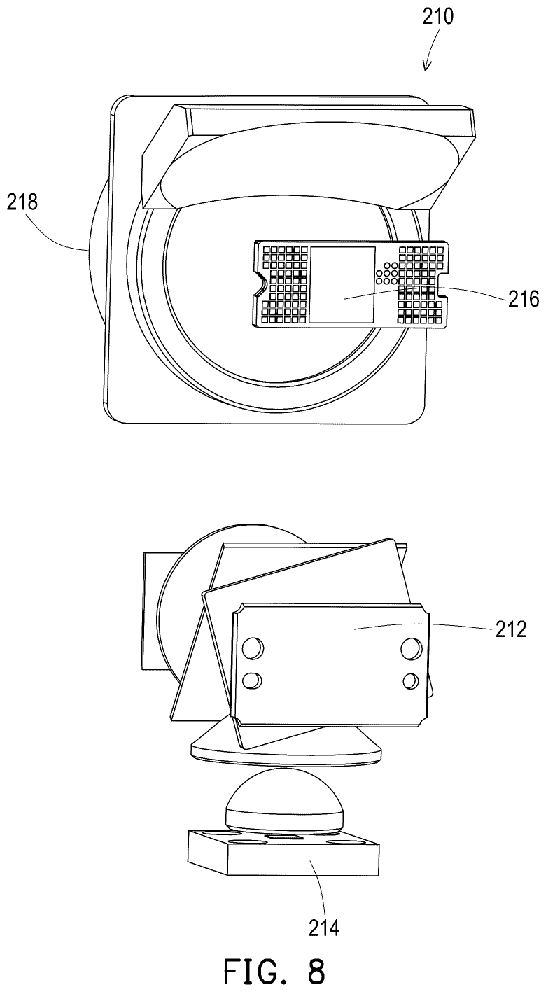

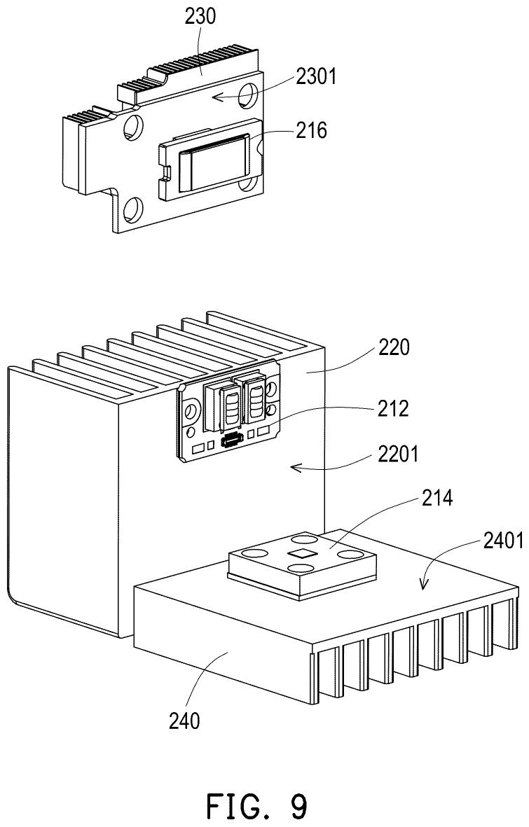

FIG. 7 is a side view of some components of a projector device according to another embodiment of the disclosure. FIG. 8 is a perspective view of some components of the device body in FIG. 7. FIG. 9 shows that the light emitting element, the light valve, and the wavelength conversion element of FIG. 8 are respectively connected to the first heat dissipation component, the second heat dissipation component, and the third heat dissipation component. In a projector device 200 shown in FIGS. 7 to 9, the configuration and function of a device body 210, a light emitting element 212, a wavelength conversion element 214, a light valve 216, a projection lens 218, a first heat dissipation component 220, a second heat dissipation component 230, a third heat dissipation component 240, a heat dissipation fan 250, a second circuit board 280, and a heat generating element 282 are the same or similar to the configuration and function of the device body 110, the light emitting element 112, the wavelength conversion element 114, the light valve 116, the projection lens 118, the first heat dissipation component 120, the second heat dissipation component 130, the third heat dissipation component 140, the heat dissipation fan 150, the second circuit board 180, and the heat generating element 182 shown in FIGS. 1 to 6, which are not repeated herein. The main differences between the projector device 200 and the projector device 100 are as follows.

A first contact surface 2201 of the first heat dissipation component 220 for contacting the light emitting element 212 is parallel to a second contact surface 2301 of the second heat dissipation component 230 for contacting the light valve 216. The first contact surface 2201 of the first heat dissipation component 220 for contacting the light emitting element 212 is not parallel to a third contact surface 2401 of the third heat dissipation component 240 for contacting the wavelength conversion element 218. The included angle between the first contact surface 2201 and the third contact surface 2401 is, for example, between 45 degrees and 135 degrees.

Following the above, an air inlet surface 254 perpendicular to an air outlet surface 252 of the heat dissipation fan 250 of the projector device 200 faces the second heat dissipation component 230. An air outlet surface 252 of the heat dissipation fan 250 faces the first heat dissipation component 220. The first heat dissipation component 220 is located between the heat dissipation fan 250 and the third heat dissipation component 240. A flow path P5 of the heat dissipation airflow provided by the heat dissipation fan 250 sequentially passes through the second heat dissipation component 230, the heat dissipation fan 250, the first heat dissipation component 220, and the third heat dissipation component 240.

Specifically, in this embodiment, the first heat dissipation component 220 faces the heat dissipation fan 250 along a first direction D1. The first heat dissipation component 220 faces the third heat dissipation component 240 along a second direction D2 perpendicular to the first direction D1. The projector device 200 further includes a housing 290. The first heat dissipation component 220, the second heat dissipation component 230, the third heat dissipation component 240, and the heat dissipation fan 250 are at least partially accommodated by the housing 290. The housing 290 guides the heat dissipation airflow to sequentially flow along the first direction D1 and the second direction D2. Therefore, the flow path P5 of the heat dissipation airflow sequentially passes through the heat dissipation fan 250 and the first heat dissipation component 220 along the first direction D1 and sequentially passes through the first heat dissipation component 220 and the third heat dissipation component 240 along the second direction D2. Accordingly, the heat dissipation airflow provided by the heat dissipation fan 250 may smoothly sequentially dissipate the heat from the second heat dissipation component 230, the first heat dissipation component 220, and the third heat dissipation component 240. In addition, the heat dissipation airflow may drive the airflow at the heat generating element 282 on the second circuit board 280 to dissipate the heat from the heat generating element 282.

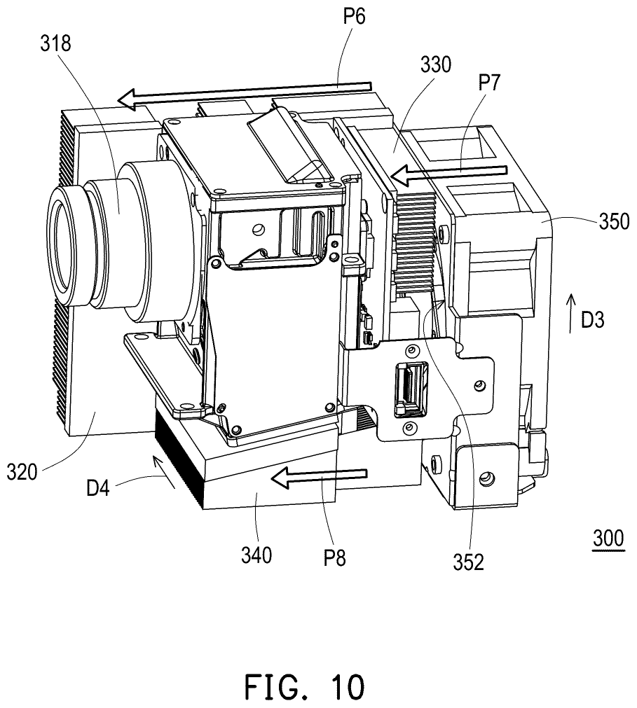

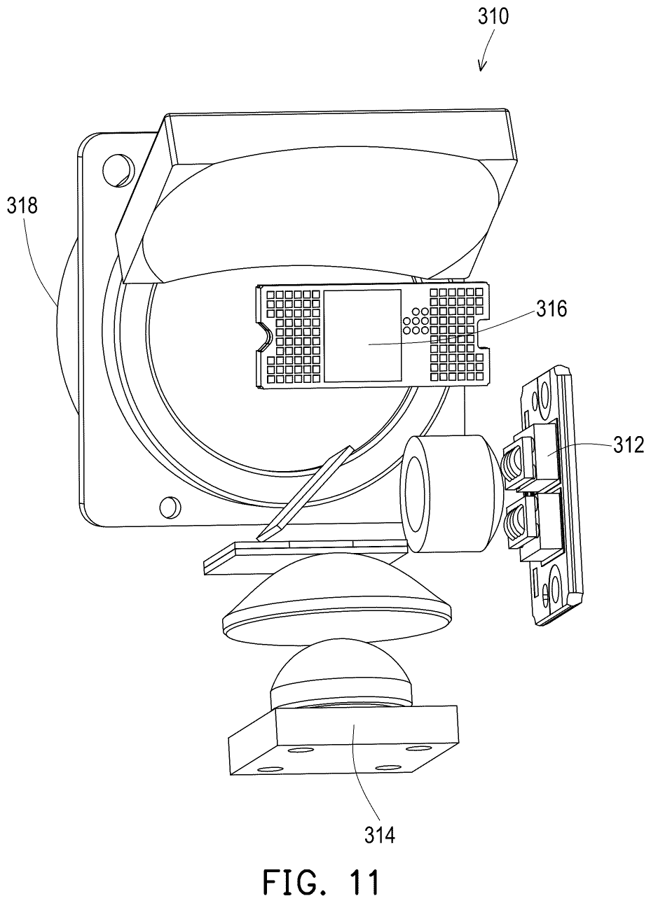

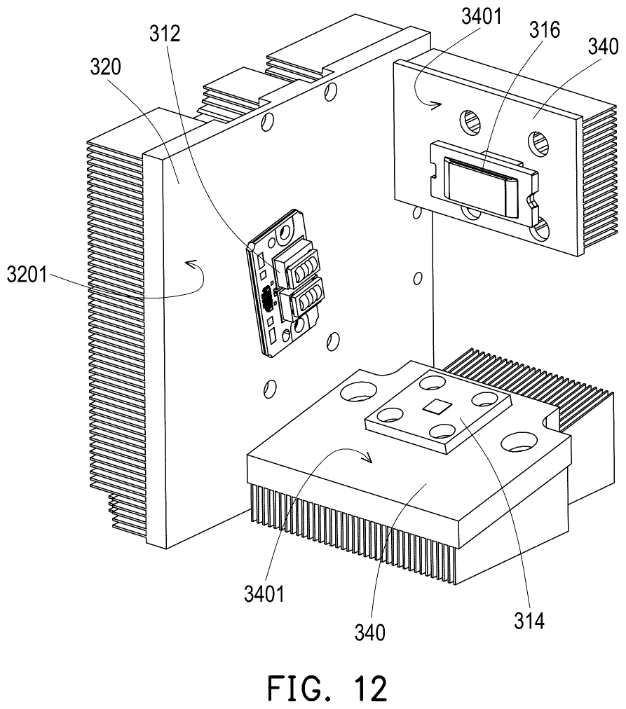

FIG. 10 is a perspective view of some components of a projector device according to another embodiment of the disclosure. FIG. 11 is a perspective view of some components of the device body of FIG. 10. FIG. 12 shows that the light emitting element, the light valve, and the wavelength conversion element of FIG. 11 are respectively connected to the first heat dissipation component, the second heat dissipation component, and the third heat dissipation component. In a projector device 300 shown in FIGS. 10 to 12, the configuration and function of a device body 310, a light emitting element 312, a wavelength conversion element 314, a light valve 316, a projection lens 318, a first heat dissipation component 320, a second heat dissipation component 330, a third heat dissipation component 340, and the heat dissipation fan 350 are the same or similar to the configuration and function of the device body 110, the light emitting element 112, the wavelength conversion element 114, the light valve 116, the projection lens 118, the first heat dissipation component 120, the second heat dissipation component 130, the third heat dissipation component 140, and the heat dissipation fan 150 shown in FIGS. 1 to 6, which is not repeated herein. The main differences between the projector device 300 and the projector device 100 are as follows.

The device body 310 does not include a light diffusion element. A first contact surface 3201 of the first heat dissipation component 320 for contacting the light emitting element 212, a second contact surface 3301 of the second heat dissipation component 330 for contacting the light valve 316, and a third contact surface 3401 of the third heat dissipation component 340 for contacting the wavelength conversion element 318 are not parallel with each other. The included angle between any two of the first contact surface 3201, the second contact surface 3301, and the third contact surface 3401 is, for example, between 45 degrees and 135 degrees.

Following the above, the second heat dissipation component 330 and the third heat dissipation component 340 overlap each other in a vertical direction D3 parallel to the air outlet surface 352. The second heat dissipation component 330 and the third heat dissipation component 340 overlap the first heat dissipation component 320 in a horizontal direction D4 parallel to the air outlet surface 352. The air outlet surface 352 of the heat dissipation fan 350 faces the first heat dissipation component 320, the second heat dissipation component 330, and the third heat dissipation component 340. A flow path P6 of the heat dissipation airflow provided by the heat dissipation fan 350 passes through the first heat dissipation component 320. A flow path P7 of the heat dissipation airflow provided by the heat dissipation fan 350 passes through the second heat dissipation component 330. A flow path P8 of the heat dissipation airflow provided by the heat dissipation fan 350 passes through the third heat dissipation component 340. Accordingly, the heat dissipation airflow provided by the heat dissipation fan 350 may smoothly dissipate the heat from the first heat dissipation component 320, the second heat dissipation component 330, and the third heat dissipation component 340.

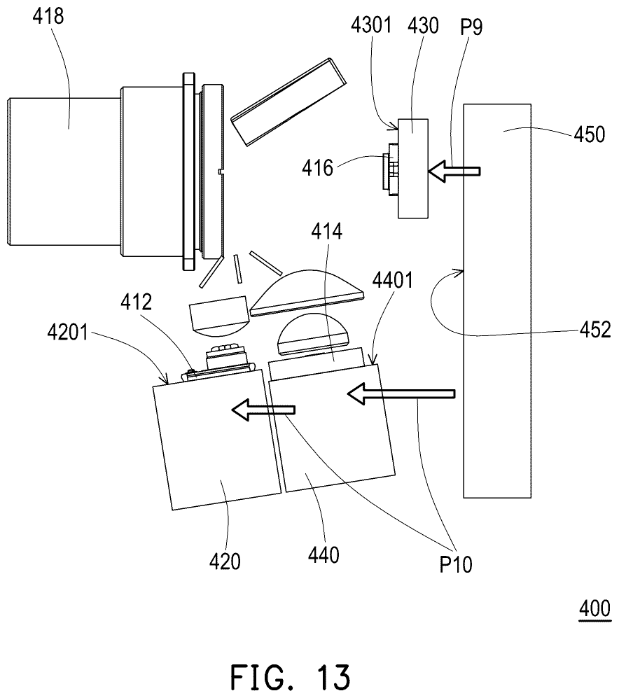

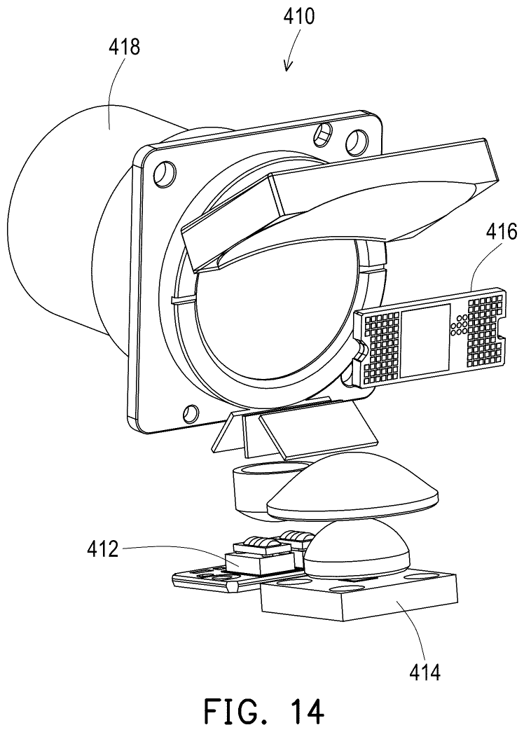

FIG. 13 is a side view of some components of a projector device according to another embodiment of the disclosure. FIG. 14 is a perspective view of some components of the device body of FIG. 13. In a projector device 400 shown in FIGS. 13 and 14, the configuration and function of a device body 410, a light emitting element 412, a wavelength conversion element 414, a light valve 416, a projection lens 418, a first heat dissipation component 420, a second heat dissipation component 430, a third heat dissipation component 440, and a heat dissipation fan 450 are the same or similar to the configuration and function of the device body 110, the light emitting element 112, the wavelength conversion element 114, the light valve 116, the projection lens 118, the first heat dissipation component 120, the second heat dissipation component 130, the third heat dissipation component 140, and the heat dissipation fan 150 shown in FIGS. 1 to 6, which is not repeated herein. The main differences between the projector device 400 and the projector device 100 are as follows.

The device body 410 does not include the light diffusion element. A first contact surface 4201 of the first heat dissipation component 420 for contacting the light emitting element 412 is parallel to a third contact surface 4401 of the third heat dissipation component 440 for contacting the wavelength conversion element 418. The first contact surface 4201 of the light emitting element 412 for contacting the light emitting element 412 is not parallel to a second contact surface 4301 of the second heat dissipation component 430 for contacting the light valve 416. The included angle between the first contact surface 4201 and the second contact surface 4301 is, for example, between 45 degrees and 135 degrees.

Following the above, an air outlet surface 452 of the heat dissipation fan 450 faces the second heat dissipation component 430 and the third heat dissipation component 440. The third heat dissipation component 440 is located between the heat dissipation fan 450 and the first heat dissipation component 420. A flow path P9 of the heat dissipation airflow provided by the heat dissipation fan 450 passes through the second heat dissipation component 430. A flow path P10 of the heat dissipation airflow provided by the heat dissipation fan 450 sequentially passes through the third heat dissipation component 440 and the first heat dissipation component 420. Accordingly, the heat dissipation airflow provided by the heat dissipation fan 450 may smoothly dissipate the heat from the first heat dissipation component 420, the second heat dissipation component 430, and the third heat dissipation component 440.

To sum up, in the disclosure, the first heat dissipation component, the second heat dissipation component, and the third heat dissipation component respectively corresponding to the light emitting element, the light valve, and the wavelength conversion element are arranged to be located on the flow path of the heat dissipation airflow provided by the single heat dissipation fan. Thereby, the single heat dissipation fan may dissipate the heat from the first heat dissipation component, the second heat dissipation component, and the third heat dissipation component. Accordingly, there is no need to configure multiple heat dissipation fans respectively corresponding to the first heat dissipation component, the second heat dissipation component, and the third heat dissipation component, which facilitates the miniaturization design of the projector device.

What is claimed is:

1. A projector device, comprising:
a device body, comprising a light emitting element, a wavelength conversion element, a light valve, and a projection lens, wherein the light emitting element is adapted to emit an illumination beam, the wavelength conversion element is adapted to convert part of a wavelength of the illumination beam, the light valve is adapted to convert the illumination beam from the light emitting element and the wavelength conversion element into an image beam, and the projection lens is adapted to project the image beam;
a first heat dissipation component, a second heat dissipation component, and a third heat dissipation component, respectively connected to the light emitting element, the light valve, and the wavelength conversion element; and
a heat dissipation fan, having an air outlet surface and suitable for providing a heat dissipation airflow, wherein an air outlet surface faces at least one of the first heat dissipation component, the second heat dissipation component, and the third heat dissipation component, and the first heat dissipation component, the second heat dissipation component, and the third heat dissipation component are all located on at least one flow path of the heat dissipation airflow.

2. The projector device according to claim 1, wherein the air outlet surface faces the first heat dissipation component and the third heat dissipation component, the first heat dissipation component is located between the heat dissipation fan and the second heat dissipation component and has a through via, the at least one flow path includes three flow paths, one of the flow paths passes through the first heat dissipation component, another one of the flow paths sequentially passes through the through via and the second heat dissipation component, and the other one of the flow paths passes through the third heat dissipation component.

3. The projector device according to claim 2, wherein the first heat dissipation component comprises a board and a heat dissipation fin set, the board has a first opening, the heat dissipation fin set is arranged on the board and has a second opening, the first opening and the second opening are aligned with each other to form the through via.

4. The projector device according to claim 2, further comprising a frame, wherein the frame has a guide slope extending in a direction from the through via toward the second heat dissipation component.

5. The projector device according to claim 4, further comprising a first circuit board and a second circuit board, wherein the second heat dissipation component is configured on the first circuit board, and the frame is located between the first circuit board and the second circuit board to support the second circuit board away from the first circuit board.

6. The projector device according to claim 5, wherein the second circuit board has at least one heat generating element, the frame has a slot, the at least one flow path sequentially passes through the through via, a space between the first circuit board and the frame, the slot, and the at least one heat generating element.

7. The projector device according to claim 6, wherein the guide slope is formed on an edge of the slot.

8. The projector device according to claim 1, wherein the heat dissipation fan has an air inlet surface, the air inlet surface faces the second heat dissipation component, the air outlet surface faces the first heat dissipation component, the first heat dissipation component is located between the heat dissipation fan and the third heat dissipation component, and the at least one flow path sequentially passes through the second heat dissipation component, the heat dissipation fan, the first heat dissipation component, and the third heat dissipation component.

9. The projector device according to claim 8, wherein the air inlet surface is perpendicular to the air outlet surface.

10. The projector device according to claim 1, wherein the first heat dissipation component faces the heat dissipation fan along a first direction, the first heat dissipation component faces the third heat dissipation component along a second direction different from the first direction, and the at least one flow path sequentially passes through the heat dissipation fan and the first heat dissipation component, and sequentially passes through the first heat dissipation component and the third heat dissipation component in the second direction.

11. The projector device according to claim 10, further comprising a housing, wherein the first heat dissipation component, the second heat dissipation component, the third heat dissipation component, and the heat dissipation fan are at least partially accommodated by the casing, and the housing guides the heat dissipation airflow to sequentially flow along the first direction and the second direction.

12. The projector device according to claim 10, wherein the first direction is perpendicular to the second direction.

13. The projector device according to claim 1, wherein the air outlet surface faces the first heat dissipation component, the second heat dissipation component, and the third heat dissipation component, the at least one flow path comprises three flow paths, and the three flow paths respectively pass through the first heat dissipation component, the second heat dissipation component, and the third heat dissipation component.

14. The projector device according to claim 13, wherein the second heat dissipation component and the third heat dissipation component overlap each other in a vertical direction parallel to the air outlet surface, and the second heat dissipation component and the third heat dissipation component overlap the first heat dissipation component in a horizontal direction parallel to the air outlet surface.

15. The projector device according to claim 1, wherein the air outlet surface faces the second heat dissipation component and the third heat dissipation component, the third heat dissipation component is located between the heat dissipation fan and the first heat dissipation component, the at least one flow path comprises two flow paths, one of the flow paths passes through the second heat dissipation component, and another one of the flow paths sequentially passes through the third heat dissipation component and the first heat dissipation component.

16. The projector device according to claim 1, wherein when viewed along an air outlet direction of the heat dissipation fan, the first heat dissipation component, the second heat dissipation component and the third heat dissipation component all overlap the heat dissipation fan.

17. The projector device according to claim 1, wherein the first heat dissipation component has a first contact surface that contacts the light emitting element, the second heat dissipation component has a second contact surface that contacts the light valve, and the third heat dissipation component has a third contact surface that contacts the wavelength conversion element, and the first contact surface, the second contact surface, and the third contact surface are not parallel to each other.

18. The projector device according to claim 17, wherein an included angle between any two of the first contact surface, the second contact surface, and the third contact surface is between 45 degrees and 135 degrees.

19. The projector device according to claim 1, wherein the first heat dissipation component has a first contact surface that contacts the light emitting element, the second heat dissipation component has a second contact surface that contacts the light valve, the third heat dissipation component has a third contact surface that contacts the wavelength conversion element, and the first contact surface is parallel to one of the second contact surface and the third contact surface and not parallel to the other one of the second contact surface and the third contact surface.

20. The projector device according to claim 19, wherein an included angle between the first contact surface and the other one of the second contact surface and the third contact surface is between 45 degrees and 135 degrees.

21. The projector device according to claim 1, wherein the projector device is a vehicle light.
